(19) United States
(12) Patent Application Publication
(10) Pub. No.: US 2018/0124362 A1
(43) Pub. Date: May 3, 2018

(54) DISPLAY SYSTEMS AND METHODS FOR VEHICLE

(71) Applicant: FARADAY&FUTURE INC., Gardena, CA (US)

(72) Inventors: Richard S. Kim, Los Angeles, CA (US); Nicholas Max Gronenthal, Los Angeles, CA (US); Hanbin Youn, Los Angeles, CA (US)

(73) Assignee: FARADAY&FUTURE INC., Gardena, CA (US)

(21) Appl. No.: 15/397,912

(22) Filed: Jan. 4, 2017

Related U.S. Application Data
(60) Provisional application No. 62/274,483, filed on Jan. 4, 2016.

(51) Int. Cl. H04N 9/31; B62D 35/00; B62D 37/02; B60Q 1/50; B60Q 1/54; G09F 21/04; G09F 19/18

(52) U.S. Cl. CPC H04N 9/3141; B62D 35/007; B62D 37/02; B60Y 2200/114; B60Q 1/54; G09F 21/04; G09F 19/18; B60Q 1/503

(57) ABSTRACT

A display system and a display method for a vehicle is disclosed. The display system may include a display formed on a tail fin of the vehicle, the display including at least one planar structure. The display system may further include at least one projector configured to project content onto the planar structure of the display. The display system may also include a controller configured to control the at least one projector.

### CROSS-REFERENCE TO RELATED APPLICATIONS

This application claims the benefit of U.S. Provisional Application No. 62/274,483, filed on Jan. 4, 2016. The subject matter of the aforementioned application is incorporated herein by reference.

### TECHNICAL FIELD

This disclosure relates to display systems and methods for a vehicle, and more particularly, to systems and methods for displaying images or videos on a surface of a vehicle.

### BACKGROUND

Vehicles are often equipped with components that provide favorable aerodynamics allowing the vehicles to reach certain speeds while maintaining control. In particular, race cars are often designed to reach speeds of over 200 miles per hour while maintaining sufficient control to navigate a track. For example, race cars are designed with rear spoilers shaped to reduce turbulence and drag along the longitudinal axis of the car and to generate sufficient downward force onto the rear wheels to maintain contact with the road.

In some industries, vehicles are also used to provide displays including advertisement and/or banners directed to viewers. For example, in the race car industry, advertisements generate high revenue, and the banners provide race information such as assigned numbers and team colors. The displays are typically painted onto hoods, doors, and other panels of the vehicle, which generate sufficient visibility. However, these existing display methods are not suitable for video advertisements or modern social media. It would be desirable to provide dynamic methods and systems of displaying media, banners, and advertisements on vehicles, particularly in the race car industry.

The disclosed display systems and methods are directed to mitigating or overcoming one or more of the problems set forth above and/or other problems in the prior art.

### SUMMARY

One aspect of the present disclosure is directed to a display system for a vehicle. The display system may include a display formed on a tail fin of the vehicle, the display including at least one planar structure. The display system may further include at least one projector configured to project content onto the planar structure of the display. The display system may also include a controller configured to control the at least one projector.

Another aspect of the present disclosure is directed to a display method for a vehicle. The display method may include determining content for display, and causing at least one projector to project content onto a display formed on a tail fin of the vehicle. The display may include at least one planar structure.

Another aspect of the present disclosure is directed to a vehicle. The vehicle may include a tail fin and a display system. The display system may include a display formed on the tail fin of the vehicle, the display including at least one planar structure. The display system may further include at least one projector configured to project content onto the planar structure of the display. The display system may also include a controller configured to control the at least one projector.

### BRIEF DESCRIPTION OF THE DRAWINGS

FIG. 1 is a diagrammatic illustration of an exemplary vehicle display system, consistent with an embodiment of the disclosure.

FIG. 2 is a block diagram illustrating an exemplary controller for the vehicle display system of FIG. 1, consistent with an embodiment of the disclosure.

FIG. 3 is a flowchart of an exemplary vehicle display method, consistent with an embodiment of the disclosure.

### DETAILED DESCRIPTION

The disclosure is generally directed to a display system and method for dynamically displaying images onto a surface of a vehicle. In some embodiments, the display system may include at least one projector configured to display an image onto a tail fin of the vehicle. The tail fin may include features that provide stability to the vehicle and that visually display an image from the projector. For example, in some embodiments, the tail fin may include a selectively reflective film sandwiched between two transparent, rigid or semi-rigid structures.

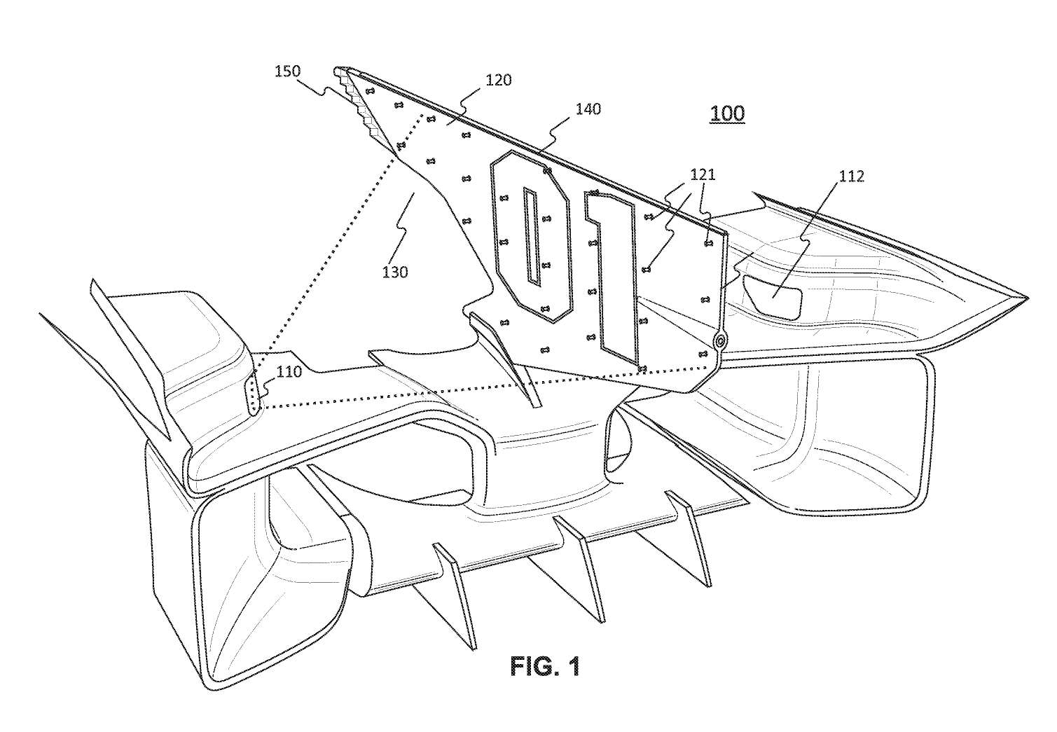

FIG. 1 is a diagrammatic illustration of an exemplary vehicle display system 100, consistent with an embodiment of the disclosure. At least some portions of vehicle display system 100 may be installed on a vehicle. The vehicle may be an automobile having any body style, such as a sports car, a coupe, a sedan, a pick-up truck, a station wagon, a sports utility vehicle (SUV), a minivan, or a conversion van. The vehicle may be an electric vehicle, a fuel cell vehicle, a hybrid vehicle, or a conventional internal combustion engine vehicle. The vehicle may be configured to be operated by a driver occupying the vehicle, remotely controlled, and/or autonomously operated. In some embodiments, the vehicle may be configured for a racing industry. For example, the vehicle may be a rally car, Formula One™ car, hot rod, touring car, a stock car, or a funny car. It is also contemplated that, the vehicle may be a boat, an airplane, or a motorcycle.

In some embodiments, as illustrated in FIG. 1, vehicle display system 100 may include at least one projector 110, a display 120, and a controller (not shown). It is contemplated that vehicle display system 100 may include more or less components as shown in FIG. 1.

Projector 110 may be installed on or embedded in a surface of the vehicle. In some embodiments, projector 110 may be on the side of a rear spoiler, facing tail fin 130. In some embodiments, system 100 may include a first projector 110 on a first side of tail fin 130 and a second projector 112 on a second side of tail fin 130, opposite of the first side, as depicted in FIG. 1. Projectors 110 and 112 may recessed within a housing of the body of the vehicle. Projectors 110 and 112 may be mechanically isolated from vibrations in the vehicle by the use of a system of shock absorbers.

Projectors 110 and 112 may be configured to project images or videos at an angle onto display 120, as depicted in FIG. 1. In some embodiments, the projection angle may be of about 30 degrees. The projection angle may be adjusted by adjusting the size of display 120, and/or the distance between projector 110 and display 120. Projectors 110 and 120 may project any suitable data, image, or video content. For example, projectors 110 and 120 may project race-related data including an assigned number (e.g., “01” as depicted in FIG. 1), livery colors (e.g., team colors), overall position of the vehicle or team in the race, etc. Projectors 110 and 120 may also project advertisement content, social media content, or data related to vehicle status, such as battery life, driver response time, breaking force, speed, g-forces, temperatures, tire status, and/or other similar types of data. In some embodiments, projectors 110 and 112 may be configured to project two- or three-dimensional images and/or videos.

Display 120 may be installed on a visible location of the vehicle to display the images and/or videos projected by projectors 110 and 112. Display 120 may display on a single side or on both sides. In some embodiments, display 120 may be located on tail fin 130. It is contemplated though, display 120 may also be located on other surfaces of the vehicle that are visible to a person external to the vehicle.

Tail fin 130 may be secured to a surface of the vehicle with a connection and extend substantially vertical from the surface of the vehicle. Tail fin 130 (e.g., a vertical stabilizer) may be shaped to limit aerodynamic drag in one direction while providing maximum drag in an orthogonal direction. In some embodiments, tail fin 130 may be shaped to create minimum aerodynamic drag along a first axis, for example, extending from the front of the vehicle to the rear of the vehicle. Tail fin 130 may also provide significant drag along a second axis, for example, extending from a left side of the vehicle to the right side of the vehicle, perpendicular to the first axis. For example, tail fin 130 may limit lateral movements at the rear of the vehicle aiding in stability as the vehicle takes corners at high speeds.

Display 120 may include a plurality of layers secured by one or more fasteners 121. For example, the layers may include planar structures, such as a projection film and one or more transparent structures. The one or more of the layers may provide a display surface for display 120, onto which an image or video may be projected. In some embodiments, display 120 may provide two planar surfaces on which the content can be projected on. For example, projector 110 may project the content on one planar surface of display 120 and projector 112 may project on the other planar surface. The content projected on the two surfaces may be the same or different.

The structural integrity of display 120 may be provided by the one or more transparent structure(s). In some embodiments, the transparent structure(s) may be semi-rigid in order to provide sufficient rigidity to limit deflection yet retain some flexibility to resist destructive shear forces. In some embodiments, the material may be rigid, while the connection may be a semi-rigid to provide a similar ability to resist destructive shear forces. For example, the transparent structure(s) may include semi-rigid sheet(s) of an acrylic (e.g., plexiglass) and/or other polymers.

In some embodiments, display 120 may include a projection film that is transparent to a first set of frequencies of light and reflective of a second set of frequencies of light. For example, in some embodiments, the projection film may be transparent to most visible frequencies of light while reflective of a specific range of visible frequencies of light. For instance, the projection film may be sandwiched between the two transparent structures creating a display surface that may be transparent to outdoor light but reflective of light frequencies that are projected by the projector(s). For example, in some embodiments, the projection film may include Glassfire™ or Silver Film™ produced by Glimm Screens International™.

As depicted in FIG. 1, the layers of display 120 may be held together by fasteners 121. In some embodiments, an array of fasteners 121 may be used. Fasteners 121 may be positioned at an equidistance from each other, such that they form a grid. In some embodiments, fasteners 121 may be used as guides by the display system. Fasteners 121 may be used as a grid system to project information in a standardized form. For example, the data may not be randomly projected on display 120 but instead projected onto certain parts of the fastener grid. In some embodiments, the image pixels being projected may be mapped to fasteners 121, in other words, registered to the grid provided by fasteners 121. Using fasteners 121 as a reference coordinate may help improve the image quality of the projected image or video.

In some embodiments, tail fin 130 may further include edge lighting brake lights 140, and rear LED lighting 150. Edge lighting brake lights may be on when the vehicle brakes. Rear LED lighting 150 may be used for various indication purposes. For example, rear LED lighting 150 may include an array of LED lights. The LED lights may be on, flashing, or blinking, simultaneously or individually, to indicate a vehicle status/condition, such as vehicle speed, battery state of charge, temperature, etc.

Projectors 110, 112, and display 120 may be electrically coupled to a controller or connected to the controller via a network. The controller may cause projectors 110 and 112 to project determined content to display 120. For example, the controller may send control signals to actuators that actuate projectors 110 and 112. The actuators may adjust the position, orientation, projection angle, and on/off of the projectors.

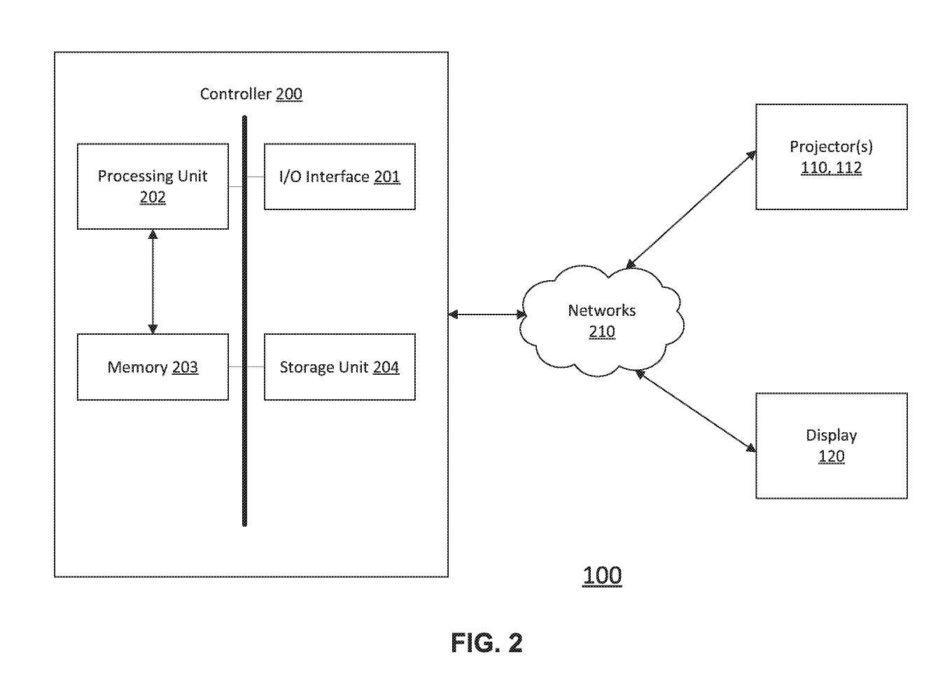

FIG. 2 is a block diagram illustrating an exemplary controller 200 for vehicle display system 100 of FIG. 1. Controller 200 may include an I/O interface 201, a processing unit 202, a memory 203, and a storage unit 204. One or more of the components of controller 200 may be included in an on-board computer of the vehicle. I/O interface 201 may send and receive data from vehicle sensors, external servers, tail fin 130, and projectors 110, 112 via one or more networks 210. networks 210 may include any type of wired or wireless network that may allow transmitting and receiving data. For example, networks 210 may include a nationwide cellular network, a local wireless network (e.g., Bluetooth™ or WiFi), a wired network, and/or other communication means.

Processing unit 202 may include or be part of one or more processing devices, such as, for example, a microprocessor. Processing unit 202 may include any type of a single or multi-core processor, a mobile device, a microcontroller, a central processing unit, a graphics processing unit, etc. Processing unit 202 may be configured to receive and process data to determine a plurality of conditions of the vehicle. Processing unit 202 may also be configured to generate and transmit data and command signals, via I/O interface 201, in order to actuate the devices in communication.

In some embodiments, processing unit 202 may be configured to receive data from vehicle sensors, and cause projectors 110 and 112 to display data including a status of the vehicle, battery life, driver response time, breaking force, speed, g-forces, temperatures, tire status, and/or other similar types of data, through display 120. In some embodiments, processing unit 202 may be configured to download data from a server related to a vehicle race, and cause projectors 110 and 112 to display data including an assigned number (e.g., “01” as depicted in FIG. 1), livery colors (e.g., team colors), overall position of the vehicle or team in the race, and/or any other similar types of data. In some embodiments, processing unit 202 may be configured to download data from third party servers, and cause projectors 110 and 112 to display data including advertisements and social media data, such as tweets or other comments addressed to the vehicle and social media trending data. Processing unit 202 may be controlled remotely by a user (e.g., a driver or a race official) and/or automatically based on predetermined rules.

Processing unit 202 may execute computer instructions (program codes) stored in memory 203 and/or storage unit 204, and may perform exemplary functions in accordance with techniques described in this disclosure. Memory 203 and/or storage unit 204 may include any appropriate type of storage provided to store any type of information that processing unit 202 may use for operation. Memory 203 and storage unit 204 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 203 and/or storage 204 may also be viewed as what is more generally referred to as a “computer program product” having executable computer instructions (program codes) as described herein. Memory 203 may be configured to store one or more computer programs that may be executed by processing unit 202 to perform exemplary functions disclosed in this application. Memory 203 and/or storage unit 204 may be further configured to store data used by processing unit 202. For example, storage unit 204 may store the various data, image, or video content to be projected by projectors 110 and 112, such as race data of the vehicle and predetermined rules of the vehicle sensors.

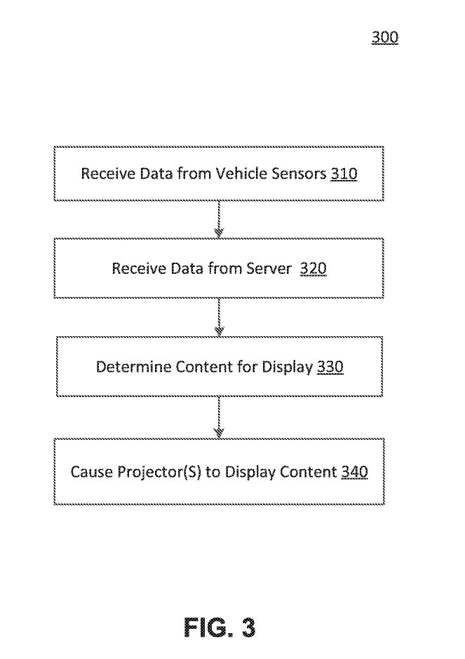

FIG. 3 is a flowchart of an exemplary vehicle display method 300, consistent with an embodiment of the disclosure. In step 310, controller 200 may receive data from vehicle sensors. Such data may include, but not limited to, vehicle position, speed, g-force, temperature, battery charge, etc. In step 320, controller 200 may further receive data from a remote server via network 210. Such data may include, but not limited to, advertisement content, social media content, race related information, etc. In step 330, controller 200 may determine content for display based on the received sensor data and/or server data. In step 340, controller 200 may cause projectors 110 and 112 to project the determined content onto display 120. Controller 200 may send control signals to actuators coupled to projectors 110 and 112. In some embodiments, the content may be projected to both side surfaces of display 120. For example, projector 110 may project to one display surface of display 120, and projector 112 may project to the other display surface of display 120. Depending on the content, controller 200 may adjust the position, orientation, and projection angle of projections 110 and 112. In some embodiments, as part of step 340, controller 200 may map the content to a grid system formed by fasteners 121.

Another aspect of the disclosure is directed to a non-transitory computer-readable medium storing instructions which, when executed, cause one or more processors to perform the methods as discussed above. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

Although the disclosure illustrates an exemplary vehicle display system utilizing the tail fin of a vehicle as the display, the display system may be applied to any number of other surfaces. For example, the display system may be applied to doors, roofs, hoods, grills, and/or other panels of vehicles. The display system may also be applied to non-vehicle applications.

It will be apparent to those skilled in the art that various modifications and variations can be made to the disclosed control system and related methods. Other embodiments will be apparent to those skilled in the art from consideration of the specification and practice of the disclosed control system and related methods. It is intended that the specification and examples be considered as exemplary only, with a true scope being indicated by the following claims and their equivalents.

What is claimed is:

1. A display system for a vehicle, the display system comprising:
a display formed on a tail fin of the vehicle, the display including at least one planar structure;
at least one projector configured to project content onto the planar structure of the display; and
a controller configured to control the at least one projector.

2. The display system of claim 1, wherein the at least one planar structure includes a projection film that is transparent to a first set of visible light frequencies and reflective of a second set of visible light frequencies.

3. The display system of claim 2, wherein the at least one planar structure further includes first and second transparent structures, wherein the projection film is sandwiched between the first and second transparent structures.

4. The display system of claim 3, wherein the display further comprises a plurality of fasteners configured to connect the projection film to the first and second transparent structures.

5. The display system of claim 4, wherein the plurality of fasteners form a grid system configured to guide the display of the content.

6. The display system of claim 1, wherein the content includes data related to a race attended by the vehicle.

7. The display system of claim 1, wherein the controller is further configured to:
receive vehicle status data from one or more sensors; and
determine the content for display based on the vehicle status data.

8. The display system of claim 1, wherein the at least one projector is configured to be housed in the vehicle.

9. The display system of claim 1, wherein the at least one projector includes a first projector and a second projector, the first projector positioned on a first side of the tail fin, and the second projector positioned on a second side of the tail fin opposite of the first projector.

10. The display system of claim 9, wherein the planar structure includes a first planar surface and a second planar surface, wherein the first projector is configured to project onto the first planar surface and the second projector is configured to project onto the second planar surface.

11. The display system of claim 1, wherein the at least one projector is configured to project the content at a projection angle of about 30 degrees.

12. The display system of claim 1, wherein the projected content is received from an external server via a network.

13. A display method for a vehicle, the display method comprising:
determining content for display; and
causing at least one projector to project content onto a display formed on a tail fin of the vehicle, the display including at least one planar structure.

14. The display method of claim 13, further comprising:
receiving vehicle status data from one or more sensors; and
determining the content for display based on the vehicle status data.

15. The display method of claim 13, wherein the planar structure has a first planar surface and a second planar surface, wherein the content is projected onto the first and second planar surfaces.

16. The display method of claim 15, wherein the at least one projector includes a first projector and a second projector, the first projector positioned on a first side of the tail fin, and the second projector positioned on a second side of the tail fin opposite of the first projector, wherein the first projector is configured to project onto the first planar surface and the second projector is configured to project onto the second planar surface.

17. The display method of claim 13, wherein the display includes a plurality of fasteners configured to connect a plurality of layers of the display, wherein the display method further includes mapping the content to a grid system formed by the plurality of fasteners.

18. The display method of claim 13, wherein the content includes data related to a race attended by the vehicle.

19. A vehicle, comprising:
a tail fin; and
a display system, including:
a display formed on the tail fin, the display including at least one planar structure;
at least one projector configured to project content onto the planar structure of the display; and
a controller configured to control the at least one projector.

20. The vehicle of claim 19, wherein the at least one planar structure includes a projection film that is transparent to a first set of visible light frequencies and reflective of a second set of visible light frequencies, and wherein the at least one planar structure further includes first and second transparent structures, wherein the projection film is sandwiched between the first and second transparent structures.
